(19) United States
(12) Patent Application Publication
(10) Pub. No.: US 2010/0227506 A1
(43) Pub. Date: Sep. 9, 2010

(54) Attachment Member Surface-Mount Component Comprising the Attachment Member, and Mounting Structure Using the Attachment Member

(76) Inventor: Yuzo Kawahara, Kanagawa-ken (JP)

Correspondence Address: BARLEY SNYDER, LLC, 1000 WESTLAKES DRIVE, SUITE 275, BERWYN, PA, 19312, US

(21) Appl. No.: 12/160,342

(22) PCT Filed: Jan. 11, 2007
(86) PCT No.: PCT/JP2007/050251

§ 371 Date: Jul. 9, 2008

(30) Foreign Application Priority Data
Jan. 12, 2006 (JP) 2006-004422

(51) Int. Cl. H01R 13/46

(52) U.S. Cl. 439/625

(57) ABSTRACT

An electrical connector includes an insulating housing provided with a mating connector receiving recessed part for receiving a mating connector. The housing includes side surfaces provided with attachment member accommodating recessed parts. A metal plate is accommodated in each of the attachment member accommodating recessed parts. The metal plate includes a fastening part and a solder connection part. The solder connection part extends downward from a lower edge of the fastening part.

### CROSS-REFERENCE TO RELATED APPLICATIONS

This application claims the benefit of the filing date under 35 U.S.C. §120 of International Patent Application No. PCT/JP2007/050251 filed Jan. 11, 2007 that claims the priority of Japanese Patent Application No. 2006-004422 filed Jan. 12, 2006.

### FIELD OF THE INVENTION

The present invention relates to an attachment member for connecting an object to be connected by soldering onto the surface of a circuit board, a surface-mount component comprising the attachment member, and a mounting structure using the attachment member.

### BACKGROUND

Surface-mount components such as electrical connectors that are mounted on a circuit board have conventionally been provided with attachment members for connecting such a surface-mount component by soldering onto the surface of a circuit board. Attachment members that have been known as such attachment members include attachment members which are constructed from plate-form components and which are fastened to both side surfaces of the surface-mount component and connected by soldering onto the surface of the circuit board, or attachment members which are provided as part of a metal shell that covers the surface-mount component and which are connected by soldering onto the surface of the circuit board.

The attachment member shown in FIG. 9 (see Japanese Patent Application Kokai No. H10-21993), for example, has been known as a conventional example in which attachment members are provided as part of a shell that covers such a surface-mount component. FIG. 9 is a perspective view of one example of a conventional shield connector.

A shield connector 101 shown in FIGS. 9 and 10 is designed to be mounted on a circuit board PCB, and comprises an insulating housing 110 that has a plurality of contacts 111, a coaxial contact 112, and a metal shell 120 that covers the housing 110. The shell 120 comprises an upper shell 120a having downwardly facing side walls 121, 121 at both ends and a lower shell 120b having upwardly facing side walls 126, 126 at both ends.

Furthermore, attachment members 124, each comprising a horizontal part 122 that extends horizontally outward and an engaging projection 123 that is bent from the tip end of the horizontal part 122 and then extends upward, are respectively provided substantially in the central portions at the lower ends of the two side walls 121 of the upper shell 120a. Moreover, a pair of leg parts 125 protrudes downward from the lower end of each of the two side walls 121 of the upper shell 120a.

This shield connector 101 is designed to be mounted on the circuit board by passing the leg parts 125 through through-holes formed in the circuit board PCB and making solder connection, and also by connecting all of the horizontal parts 122 of the fastening parts 124 by soldering to the surface of the circuit board PCB.

Here, the shield connector 101 mounted on the circuit board maintains the board holding strength with respect to the circuit board PCB as a result of the leg parts 125 being connected by soldering to the through-holes formed in the circuit board PCB. This circuit board holding strength is reinforced by connecting all of the horizontal parts 122 of the fastening parts 124 by soldering to the surface of the circuit board PCB.

Accordingly, in cases where an external force acts in a direction in which the shield connector 101 is pulled away from the circuit board PCB in the state of being mounted on the circuit board PCB, this pulling away can be prevented by possessing the board holding strength with respect to the circuit board PCB by the leg parts 125 and the fastening parts 124.

However, the following problems have been encountered in the conventional shield connector 101 shown in FIG. 9. Specifically, as shown in FIG. 10, when all of the horizontal parts 122 of the fastening parts 124 are connected by soldering to a circuit board PCB, solder fillets 130 are formed along the circumferences of the horizontal parts 122. In this state, if an external force causes the shield connector 101 to move in the horizontal directions indicated by arrows A or if an external force acts which pulls the shield connector 101 apart in the vertical direction indicated by arrow B, due to vibration, changes in ambient temperature, or other such factors, the force in the horizontal directions indicated by the arrows A and the force in the vertical direction indicated by the arrow B act on the fastening parts 124 provided on the upper shell 120a. In this case, because the fastening parts 124 are part of the shell 120 mounted on the housing 110 of the shield connector 101, stress tends to be concentrated in the portions of the solder fillets 130 indicated by “a” on the side of the shield connector 101. That is, among the solder fillets 130 attached to the horizontal parts 122, the portions of the solder fillets 130 indicated by the “a” on the side of the shield connector 101 contribute most significantly to the board holding strength, and the degree of contribution of the other portions is low. Therefore, while the board holding strength is not increased much even if the horizontal parts 122 are extended outward more than necessary and connected by soldering, this ends up creating the problem of increasing the mounting areas of the fastening parts 124, i.e., the mounting area of the shield connector 101.

### SUMMARY

Accordingly, the present invention was devised in light of the problems described above. It is an object of the present invention to provide an attachment member that can prevent a drop in the circuit board holding strength even if the mounting area is made smaller than in the past, a surface-mount component comprising the attachment members, and a mounting structure using the attachment member.

This and other objects are achieved by an electrical connector comprising an insulating housing provided with a mating connector receiving recessed part for receiving a mating connector. The housing includes side surfaces provided with attachment member accommodating recessed parts. A metal plate is accommodated in each of the attachment member accommodating recessed parts. The metal plate includes a fastening part and a solder connection part. The solder connection part extends downward from a lower edge of the fastening part.

### BRIEF DESCRIPTION OF THE DRAWINGS

FIG. 1 is a perspective view of an electrical connector used as a surface-mount component comprising the attachment members of the present invention;

FIG. 2 shows the electrical connector of FIG. 1, with FIG. 2(A) being a front view, FIG. 2(B) being a left side view, and FIG. 2(C) being a sectional view along line 2C-2C in FIG. 2(B);

FIG. 3 is a perspective view of the attachment member of the present invention as seen from the side that is on the outside when mounted on a housing;

FIG. 4 shows the attachment member of FIG. 3, with FIG. 4(A) being a plan view, FIG. 4(B) being a front view, FIG. 4(C) being a bottom view, FIG. 4(D) being a right side view, and FIG. 4(E) being a rear view;

FIG. 5 is a perspective view showing a state in which the electrical connector of FIG. 1 is mounted on a circuit board;

FIG. 6 shows a state in which a solder connection part of each of the attachment members is connected by soldering onto a conductive pad provided on a surface of the circuit board, with FIG. 6(A) being a front view, FIG. 6(B) being a right side view, and FIG. 6(C) being a sectional view along line 6C-6C in FIG. 6(A);

FIG. 7 is a diagram for illustrating the concentration of stress in cases where the attachment member whose solder connection part is not formed in the shape of a letter U is connected by soldering onto the circuit board, and an external force acts the attachment member;

FIG. 8 is a diagram for illustrating the dispersion of stress in cases where the attachment member of the present invention shown in FIG. 3 is connected by soldering onto the circuit board, and an external force acts on the attachment member;

FIG. 9 is a perspective view of one example of a conventional shield connector; and

FIG. 10 is a diagram for illustrating the concentration of stress in cases where an external force acts on the attachment members in the shield connector shown in FIG. 9.

### DETAILED DESCRIPTION OF THE EMBODIMENT(S)

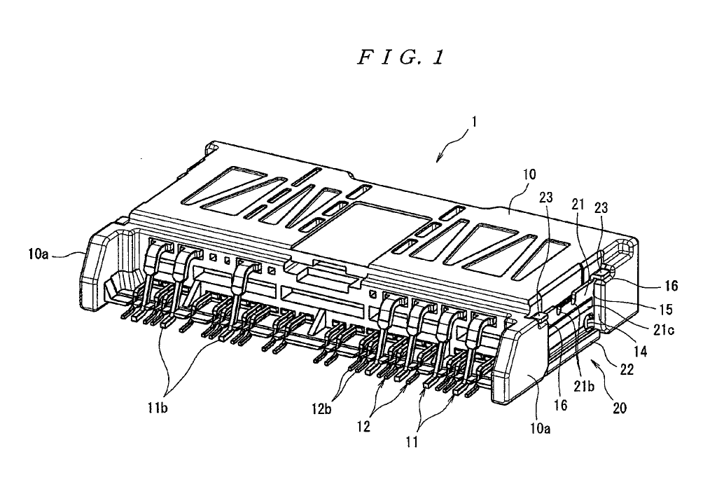

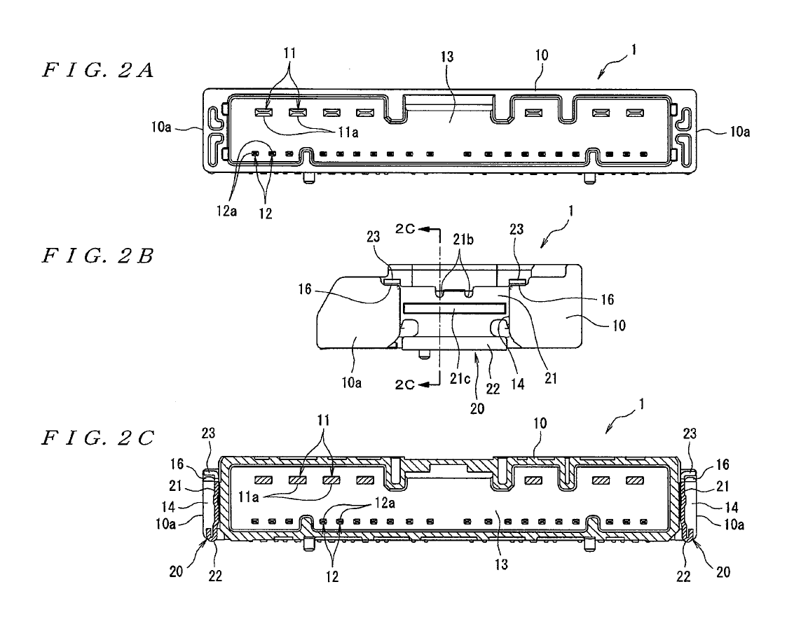

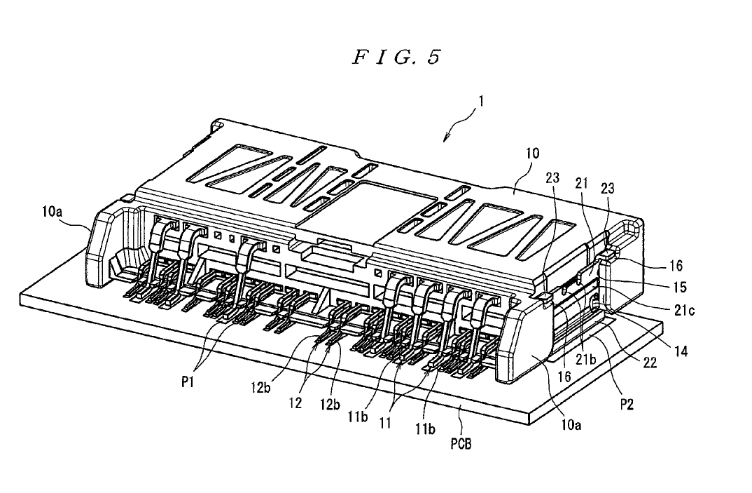

Next, an embodiment of the present invention will be described with reference to the figures. An electrical connector (surface-mount component) 1 shown in FIGS. 1, 2A, 2B, and 2C is designed to be mounted on a circuit board PCB (FIG. 5), and comprises an insulating housing (object of connection) 10 having a plurality of power contacts 11, a plurality of signal contacts 12, and a pair of attachment members 20 for connecting the housing 10 by soldering onto a surface of the circuit board PCB. Here, the housing 10 is formed in a substantially rectangular shape by molding an insulating resin, and comprises a mating connector receiving recessed part 13 that opens on the front surface (right surface in FIG. 2B) of the housing 10. The power contacts 11 and the signal contacts 12 respectively comprise contact parts 11a and 12a that protrude into the mating connector receiving recessed part 13, as shown in FIGS. 2A and 2C, and board connecting parts 11b and 12b that are connected by soldering onto the surface of the circuit board PCB, as shown in FIG. 5. Furthermore, a mating connector (not shown in the figures) is received inside the mating connector receiving recessed part 13, so that the mating contacts (not shown in the figures) provided on the mating connector respectively make contact with the contact parts 11a and 12a of the power contacts 11 and the signal contacts 12. Moreover, a pair of attachment member accommodating recessed parts 14, 14 is respectively formed substantially in the central portions in the forward-rearward direction of two side surfaces 10a, 10a of the housing 10, as shown in FIGS. 1, 2A, 2B, and 2C. A pair of fastening part recessed parts 15, 15 that receive both ends of the fastening part 21 of each of the attachment members 20 (described later) are respectively formed in the front wall and rear wall of each of the attachment member accommodating recessed parts 14, as shown in FIG. 1 (FIG. 1 shows only the fastening part recessed part 15 formed in the front wall part of the attachment member accommodating recessed part 14 on one side). Furthermore, shoulder parts 16, 16 that are respectively contacted by a pair of holding parts 23, 23 (described later) of the attachment member 20 are provided on the upper surfaces of each of the side surfaces 10a, 10a of the housing 10 on the front side and the rear side of each of the attachment member accommodating recessed parts 14.

Moreover, the pair of the attachment members 20 are designed to be respectively accommodated inside the attachment member accommodating recessed parts 14 formed in the side surfaces 10a, 10a of the housing 10, as shown in FIG. 2C. Each of the attachment members 20 is formed by stamping and forming a metal plate. As shown in FIGS. 1 through 4, each of the attachment members 20 comprises the fastening part 21 whose both ends are received and press-fitted in the pair of fastening part recessed parts 15, 15 formed in each of the side surface 10a of the housing 10, and a solder connection part 22 that extends downward from the fastening part 21. The fastening part 21 is formed in a substantially rectangular plate form. A pair of cutouts 21b are formed in the upper edge, and a plurality of locking projections 21a that are press-fitted in the fastening part recessed parts 15, 15 of the housing 10 are provided so as to protrude from both edges of the fastening part 21 in the direction of width. A rib 21c formed by coining is formed substantially in the central portion in the vertical direction of the fastening part 21. The rib 21c has the function of reinforcing the plate-form fastening part 21.

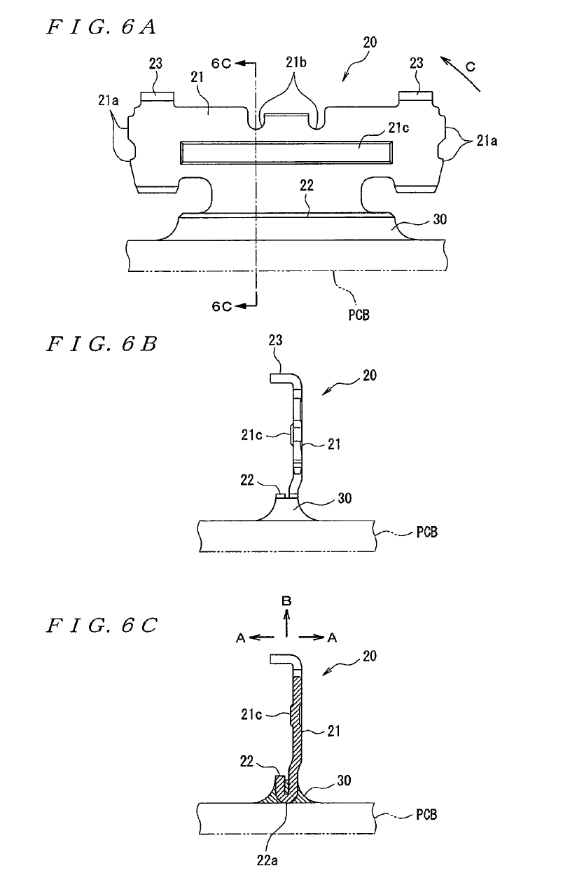

Furthermore, the solder connection part 22 extends downward substantially from the central portion in the direction of width of the lower edge of the fastening part 21 and is designed to be connected by soldering onto the surface of the circuit board PCB, as shown in FIG. 5. As shown in FIGS. 1, 2C, 3, 4D, and 5, the lower end portion of the solder connection part 22 is bent back outward (outward in the direction of width of the housing 10) in the shape of the letter U, so that a rectilinear ridge part 22a thereof contacts the surface of the circuit board PCB (see FIG. 6C).

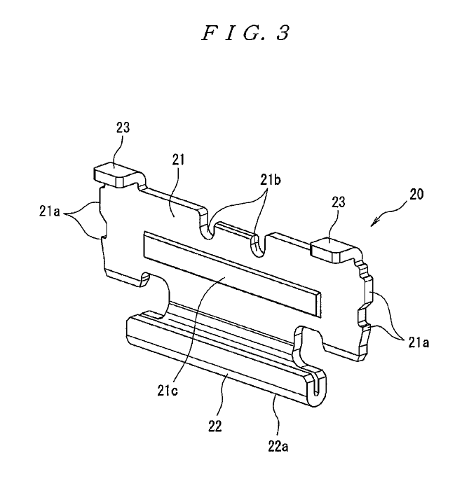

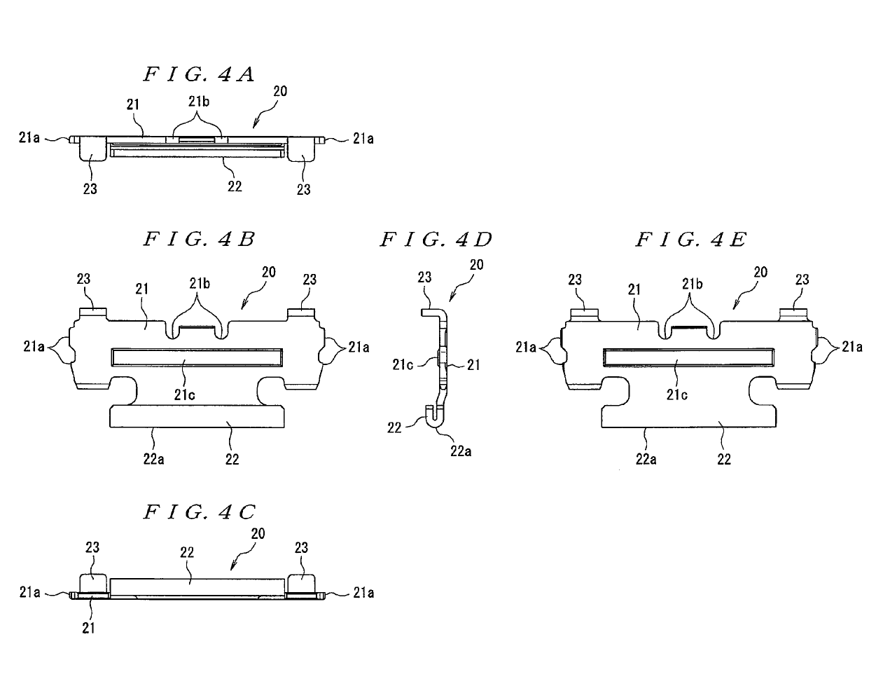

Moreover, as shown in FIGS. 3, 4A, 4B, 4C, 4D, and 4E, the pair of the holding parts 23, 23 that are bent outward are provided at either end in the direction of width of the upper edge of the fastening part 21 of each of the attachment members 20. As shown in FIG. 1, the holding parts 23, 23 respectively contact the shoulder parts 16, 16 formed on the housing 10, and have the function of reinforcing the joining of the attachment member 20 and the housing 10 together with the fastening part 21 when the electrical connector 1 is mounted on the circuit board PCB.

In addition, when the electrical connector 1 is mounted on the circuit board PCB, as shown in FIG. 5, the board connecting parts 11b of the power contacts 11 and the board connecting parts 12b of the signal contacts 12 are respectively connected by soldering onto conductive pads P1 provided on the surface of the circuit board PCB, and the solder connection parts 22 of the attachment members 20 are respectively connected by soldering onto conductive pads P2 provided on the surface of the circuit board PCB. The mounting strength of the electrical connector 1 mounted on the circuit board PCB with respect to the circuit board PCB is maintained mainly by the solder connection parts 22 of the respective attachment members 20 being connected by soldering onto the conductive pads P2 provided on the surface of the circuit board PCB.

FIGS. 6A, 6B, and 6C show a state in which the solder connection part 22 of each of the attachment members 20 is connected by soldering onto the conductive pads P1, P2 provided on the surface of the circuit board. As shown in FIGS. 5, 6A, 6B, and 6C, when the solder connection parts 22 of the respective attachment members 20 are connected by soldering onto the conductive pads P2 provided on the surface of the circuit board PCB. Solder fillets 30 are formed around the solder connection parts 22. Furthermore, because the lower end portions of the solder connection parts 22 are bent back outward in the shape of the letter U, as shown in FIG. 6C, and the rectilinear ridge parts 22a thereof contact the surface of the circuit board PCB, the solder fillets 30 are formed on both sides of the U-shaped ridge parts 22a. Therefore, it is possible to increase the board holding strength of the attachment members 20 per each mounting area, thus making it possible to prevent a drop in the circuit board holding strength even if the mounting area is made smaller than in the past. Because the mounting area of the attachment members 20 can be reduced, the mounting area of the electrical connector 1 can be reduced as a result. Consequently, in a state in which the solder connection parts 22 of the respective attachment members 20 are connected by soldering to the conductive pads P2 provided on the surface of the circuit board PCB, even if an external force that causes the attachment members 20 to move in the horizontal directions indicated by arrows A or an external force that pulls the attachment members 20 apart in the vertical direction indicated by arrow B acts on the attachment members 20, as shown in FIG. 6C, due to vibration, changes in ambient temperature, or other such factors, there is no problem, so that the bonding strength (mounting strength) that is the same as or greater than in the past can be obtained even if the mounting area is reduced. Furthermore, even if an external force that causes the attachment members 20 to rotate in the direction of arrow C, as shown in FIG. 6A (an external force that causes the attachment members 20 to rotate in the direction of the plate width of the attachment members 20) acts on the attachment members 20, because the circuit board holding strength of the attachment members 20 per each mounting area is high, this does not become an issue.

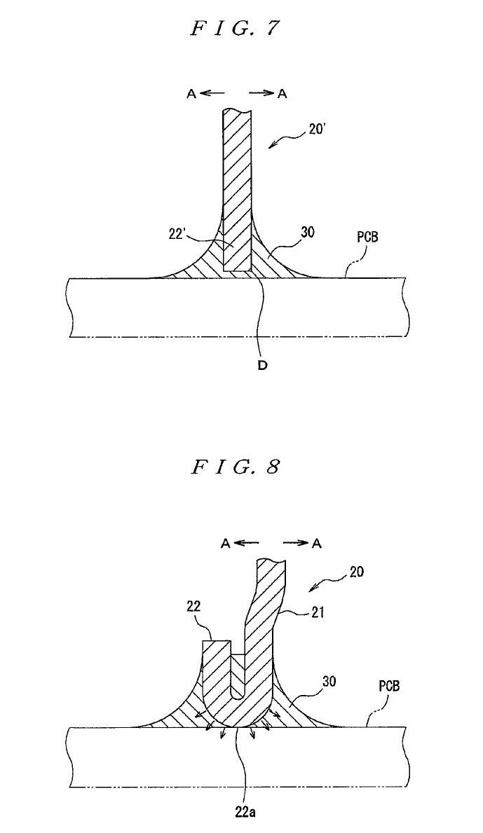

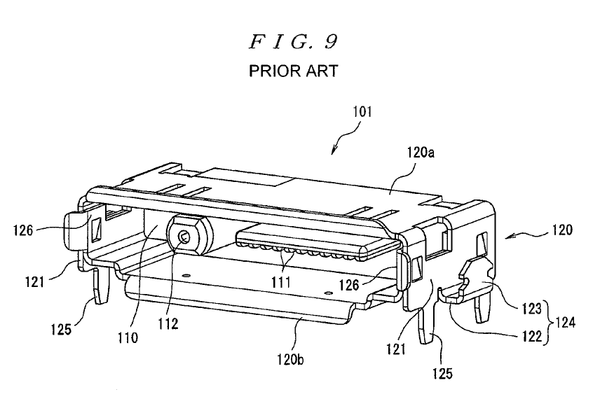

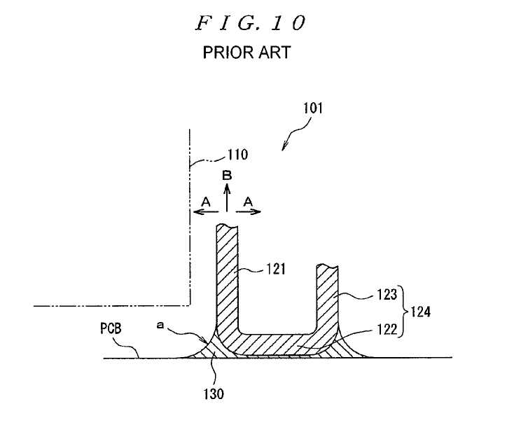

Furthermore, as shown in FIG. 7, it is also conceivable to use attachment members 20′ whose solder connection parts 22′ are not formed in the shape of the letter U in order to reduce the mounting area of the attachment members 20′ and to connect the solder connection parts 22′ of the attachment members 20′ by soldering onto the circuit board PCB in an upright state. If this is done, in cases where an external force that causes the attachment members 20′ to move in the horizontal directions indicated by the arrows A acts on the attachment members 20′, as shown in FIG. 7, due to vibration, changes in ambient temperature, or other such factors, stress on the solder is concentrated on edges D of the solder connection parts 22′, creating the risk of generating cracking in the solder, so that this is not desirable. In the case of the present embodiment, on the other hand, in cases where an external force that causes the attachment members 20 to move in the horizontal directions indicated by the arrows A acts on the attachment members 20, as shown in FIG. 8, due to vibration, changes in ambient temperature, or other such factors, stress on the solder is dispersed around the U-shaped portions of the solder connection parts 22, so that it is possible to reduce the likelihood of generating cracking in the solder.

Moreover, the pair of the holding parts 23, 23 that are bent outward are provided at either end in the direction of width of the upper edge of the fastening part 21 of each of the attachment members 20. The holding parts 23, 23 contact the shoulder parts 16, 16 formed on the housing 10, as described above, and reinforce the joining of the attachment members 20 and the housing 10 together with the fastening parts 21 when the electrical connector 1 is mounted on the circuit board PCB. If the holding parts 23, 23 are not provided, the attachment members 20 are fastened to the housing 10 solely by the thin plate-form fastening parts 21, so that in cases where an external force acts which pulls the housing 10 away from the circuit board PCB in the vertical direction indicated by the arrow B in FIG. 6C, the lower end edges or the locking projections 21a of the fastening parts 21 bite into the resin of the housing 10, creating the risk of generating cracking or breaking therein. By contrast, if the pair of the holding parts 23, 23 that hold the housing 10 by contacting the shoulder parts 16, 16 formed on the housing 10 are provided at either end in the direction of width of the upper edge of the fastening part 21 of each of the attachment members 20, as in the present embodiment, the resin constituting the shoulder parts 16, 16 of the housing 10 can be received by the holding parts 23, 23 in planar form when an external force acts which pulls the housing 10 away from the circuit board PCB in the vertical direction indicated by the arrow B, so that there is no generation of cracking or breaking in the housing 10. In addition, because the attachment members 20 are accommodated in the attachment member accommodating recessed parts 14 formed in the side surfaces 10a of the housing 10, the mounting area of the electrical connector 1 can be reduced even further.

An embodiment of the present invention has been described above. However, the present invention is not limited to this embodiment, and various alterations and modifications can be made. For example, in the present embodiment, the description involves the electrical connector 1 as a surface-mount component comprising the attachment members 20. However, it would also be possible to use relatively large components other than the electrical connector 1, e.g., terminal blocks, inductance components, or various types of module such as display elements as surface-mount components comprising the attachment members 20. Furthermore, the attachment members 20 can also be used in a component having the mounting structure of a through-hole type or the like other than a surface-mount component.

1-5. (canceled)

6. An electrical connector, comprising:
an insulating housing provided with a mating connector receiving recessed part for receiving a mating connector, the housing including side surfaces provided with attachment member accommodating recessed parts; and
a metal plate accommodated in each of the attachment member accommodating recessed parts, the metal plate including a fastening part and a solder connection part, the solder connection part extending downward from a lower edge of the fastening part.

7. The electrical connector of claim 6, wherein the fastening part includes at least one rib.

8. The electrical connector of claim 6, wherein a portion of the solder connection part that extends downward from the fastening part is offset with respect to a plane of the fastening part.

9. The electrical connector of claim 6, wherein the housing includes fastening part recessed parts and the fastening part includes locking projections on edges thereof, the locking projections being press-fitted in the fastening part recessed parts of the housing.

10. The electrical connector of claim 6, wherein the fastening part is provided with cutouts on an upper edge thereof.

11. The electrical connector of claim 6, wherein the housing includes shoulder parts and the fastening part includes holding parts that extend from an upper edge of the fastening part, the holding parts being supported by the shoulder parts of the housing.

12. The electrical connector of claim 11, wherein the holding parts extend away from the housing.

13. The electrical connector of claim 6, wherein the solder connection part includes a U-shaped ridge part.

14. The electrical connector of claim 13, wherein the U-shaped ridge part extends away from the housing.

15. The electrical connector of claim 13, wherein solder fillets are formed on both sides of the U-shaped ridge part and in a middle thereof.

16. The electrical connector of claim 13, wherein the U-shaped ridge part rests on a conductive pad on a surface of a circuit board and is electrically connected thereto.
